(19) United States
(12) Patent Application Publication
(10) Pub. No.: US 2017/0280399 A1
(43) Pub. Date: Sep. 28, 2017

(54) Managing Radio Frequency Spectrum Usage By A Wireless Network Node

(71) Applicant: QUALCOMM Incorporated, San Diego, CA (US)

(72) Inventors: George Chrisikos, San Diego, CA (US); Richard Dominic Wietfeldt, San Diego, CA (US)

(21) Appl. No.: 15/079,677

(22) Filed: Mar. 24, 2016

(51) Int. Cl. H04W 52/24; H04W 52/28

(52) U.S. Cl. CPC H04W 52/243; H04W 52/281

(57) ABSTRACT

Embodiments include systems and methods for managing radio frequency (RF) spectrum usage by a processor of a wireless network node. The processor may scan one or more frequencies to determine a spectrum usage. The processor may identify one or more high priority devices based on the scanning The processor may determine a maximum RF interference threshold of the one or more high priority devices based on the spectrum usage and the identification of the one or more high priority devices. The processor may calculate a transmit power for one or more wireless network nodes based on the determined maximum RF interference threshold, and the processor may transmit a signal at or below the calculated transmit power.

### BACKGROUND

Computing devices that include wireless communication capabilities are becoming smaller, cheaper, and increasingly ubiquitous. Such computing devices are being incorporated with more and more objects, gradually creating a massively distributed network of computing devices generally referred to as the Internet of Everything or the Internet of Things (IoT). Many types of devices with wireless communication capabilities are expected to participate in the IoT as network nodes using wireless communication. Consequently, a vast number of wireless devices may compete for wireless communication frequencies within a finite amount of frequency spectrum allocated for use in the IoT.

The U.S. Federal Communication Commission (FCC) has called for general adoption of radio frequency (RF) spectrum sharing in the 3.5 GHz band (generally 3550 MHz-3700 MHz) in three tiers (or priorities) of access. The top two tiers of access would be reserved for devices and systems that have used the spectrum historically (e.g., federal and commercial radar and satellite communications), and commercial operators that license spectrum from the government (e.g., cellular communication networks or shorter range communication networks). The third tier of access would be open to general access by any FCC-certified wireless device provided such devices do not interfere with top tier devices. Other examples of spectrum available for sharing include sharing TV Whitespace bands (400-700 MHz) (i.e., spectrum licensed for TV application but currently repurposed for shared access), future Authorized Shared Access (ASA) bands (1700 MHz Advanced Wireless Services (AWS)), Licensed Shared Access (LSA) in Europe, e.g. 2.3 GHz, and in unlicensed bands including 900 MHz, 5 GHz, and 2.4 GHz bands.

### SUMMARY

Systems, methods, and devices of various embodiments enable the management of radio frequency (RF) spectrum usage by one or more wireless network nodes among a distributed plurality of wireless network nodes. Various embodiments may include scanning one or more frequencies to determine spectrum usage, identifying one or more high priority devices based on the scanning, determining a maximum RF interference threshold of the identified one or more high priority devices based on the determined spectrum usage by the identified one or more high priority devices, calculating a transmit power for one or more wireless network nodes based on the determined maximum RF interference threshold, and transmitting a signal from one or more wireless network nodes at or below the calculated transmit power.

In some embodiments, scanning one or more frequencies to determine a spectrum usage may include scanning one or more channels in the one or more frequencies to determine spectrum usage. In some embodiments, scanning the one or more frequencies to determine spectrum usage may include measuring a received power of a signal from the identified one or more high priority devices. In some embodiments, scanning the one or more frequencies to determine spectrum usage may include determining one or more other signal characteristics of a signal of the identified one or more high priority devices.

In some embodiments, scanning one or more frequencies to determine a spectrum usage may include selecting a time interval and a frequency for scanning, measuring a signal power of a signal received from each of the identified one or more high priority devices, and determining the maximum RF interference threshold of each of the identified one or more high priority devices based on the measured signal power of signals received from each of the identified one or more high priority devices. Some embodiments may further include sending information from each wireless network node to at least one other wireless network node.

In some embodiments, calculating a transmit power for one or more wireless network nodes based on the determined maximum RF interference threshold of the identified one or more high priority devices may include determining an incurred signal loss of a signal from the identified one or more high priority devices received at the one or more wireless network nodes, determining a transmit power of each of the identified one or more high priority devices, and calculating the transmit power for the one or more wireless network nodes based on the incurred signal loss and the determined transmit power of each of the identified one or more high priority devices.

In some embodiments, calculating the transmit power for one or more wireless network nodes based on the incurred signal loss and the determined transmit power of each of the identified one or more high priority devices may include calculating the transmit power for the one or more wireless network nodes based on the incurred signal loss and the determined transmit power of the identified one or more high priority devices such that a signal transmitted at the calculated transmit power from the one or more wireless network nodes is estimated to arrive at the identified one or more high priority devices with a signal power that is less than the maximum RF interference threshold of the one or more high priority devices.

In some embodiments, transmitting a signal from one or more wireless network nodes at or below the calculated transmit power may include selecting one or more wireless network nodes to transmit, and transmitting the signal from the selected one or more wireless network nodes at or below the calculated transmit power for each selected wireless network node. In such embodiments, selecting one or more wireless network nodes to transmit may include determining a receiver sensitivity of the one or more wireless network nodes, identifying one or more of the wireless network nodes whose signal transmitted at the calculated transmit power can reach another wireless network node, and selecting the identified one or more of the wireless network nodes to transmit.

Various embodiments include a wireless network node including a processor configured with processor-executable instructions to perform operations of the methods summarized above. Various embodiments also include a non-transitory processor-readable storage medium having stored thereon processor-executable software instructions configured to cause a processor to perform operations of the methods summarized above. Various embodiments also include a wireless network node that includes means for performing functions of the methods summarized above.

### BRIEF DESCRIPTION OF THE DRAWINGS

The accompanying drawings, which are incorporated herein and constitute part of this specification, illustrate various embodiments, and together with the general description given above and the detailed description given below, serve to explain the features of various embodiments.

FIG. 1 is a system block diagram of a communication environment in which the various embodiments may be used.

FIG. 2 is a component block diagram illustrating a wireless network node suitable for use with various embodiments.

FIG. 3A is a process flow diagram illustrating a method for managing resource frequency usage by a wireless network node according to various embodiments.

FIG. 3B is a process flow diagram illustrating a method for managing resource frequency usage by a wireless network node according to various embodiments.

FIG. 3C is a process flow diagram illustrating a method for managing resource frequency usage by a wireless network node according to various embodiments.

FIG. 4 is a process flow diagram illustrating a method for managing resource frequency usage by a wireless network node according to various embodiments.

FIG. 5 is a system block diagram illustrating a high priority device and wireless network nodes.

FIG. 6 is a process flow diagram illustrating a method for managing resource frequency usage by a wireless network node according to various embodiments.

FIG. 7 is a system block diagram illustrating a high priority device and wireless network nodes.

FIG. 8 is a message flow diagram illustrating operations and communication flows for managing resource frequency usage by a wireless network node according to various embodiments.

FIG. 9 is a message flow diagram illustrating operations and communication flows for managing resource frequency usage by a wireless network node according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of various embodiments or the claims.

Various embodiments provide methods for managing resource consumption by a wireless access point based on a network load of the access point and radio capabilities of clients that are associated with the access point.

The term “wireless network node” is used herein to refer to a wireless device that may use RF communications to communicate with another device (or user), for example, as a participant in a communication network, such as the IoT. Such communications may include communications with another wireless device, a base station (including an IoT base station), an access point (including an IoT access point), or other wireless devices. A device implementing various embodiments may include any one or all of cellular telephones, smart phones, personal or mobile multi-media players, personal data assistants (PDAs), laptop computers, tablet computers, smart books, palmtop computers, gaming systems and controllers, smart appliances including televisions, set top boxes, kitchen appliances, lights and lighting systems, smart electricity meters, air conditioning/HVAC systems, thermostats, building security systems including door and window locks, vehicular entertainment systems, vehicular diagnostic and monitoring systems, unmanned and/or semi-autonomous aerial vehicles, automobiles, sensors, machine-to-machine devices, and similar devices that include a programmable processor and memory and circuitry for establishing wireless communication pathways and transmitting/receiving data via wireless communication pathways.

The term “component” is intended to include a computer-related part, functionality or entity, such as, but not limited to, hardware, firmware, a combination of hardware and software, software, or software in execution, that is configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

Devices participating in the Internet of Things (IoT) may use RF spectrum, for example, in the 3.5 GHz band (generally 3550 MHz-3700 MHz). Spectrum allocation is typically regulated, and as such should not be considered a technical limitation on any device. Certain devices and systems are assigned relatively higher communication priority. For example, federal and commercial radar and satellite communication systems may fall into a so-called “Incumbent User” tier. As another example, cellular and other communication networks that use commercially licensed spectrum, small cell networks that may include 3G/4G/5G cellular technology and/or Wi-Fi, LTE in Unlicensed spectrum (LTE-U), License Assisted Access (LAA), or MuLTEfire (a system that uses LTE on an unlicensed carrier band) may fall into a so-called “Priority Access Level” tier. Devices and systems that are not designated Priority Access Level or Incumbent User devices generally fall into a third tier, a so-called “General Authorized Access” tier, which is open to any device certified by the Federal Communication Commission. Devices in the Incumbent User tier and the Priority Access Level tier are collectively referred to herein “high priority devices” to distinguish such devices from General Authorized Access devices, which are referred to as “lower priority devices” or “low priority devices.”

Lower priority devices are required (by federal regulations) to avoid generating transmissions that interfere with communications of high priority devices. Thus, lower priority devices may use the RF spectrum if no higher priority devices are using the spectrum (e.g., not present or present but not transmitting). Because of the sheer number of devices that may periodically use IoT-allocated frequencies, central coordination of the frequency band and transmission power used by each device for transmission may be very difficult, if not impossible.

The various embodiments provide methods implemented by a processor on a wireless network node (e.g., a wireless device in an IoT) to manage RF spectrum usage. A distributed plurality of wireless network nodes may sense and share information regarding RF spectrum usage. Using the shared information regarding RF spectrum usage, a wireless network node (e.g., any IoT device receiving the RF spectrum usage information) may select a transmission power level, a transmission frequency, a transmission time, and one or more of the wireless network nodes to transmit. Some embodiments enable each wireless network node to use the distributed plurality of wireless network nodes as a network of RF sensors to construct a map of RF spectrum usage. In some embodiments, the plurality of wireless network nodes may be lower priority devices, and the RF spectrum usage map may include information about spectrum usage by one or more high priority devices.

In various embodiments, the distributed plurality of wireless network nodes may scan one or more frequencies and may receive one or more RF signals from one or more high priority devices. In some embodiments, each of the wireless network nodes may scan one or more frequencies at its respective location across one or more target frequency bands (for example, but not limited to, IoT-allocated frequency bands) to sense and measure spectrum usage. In some embodiments, each wireless network node may scan one or more channels in the one or more target frequency bands. In some embodiments, the wireless network nodes may measure a received signal power in the one or more frequencies. In some embodiments, the wireless network nodes may also determine one or more other signal characteristics of a received signal. The signal characteristics may include one or more of timing/periodicity and typical duration of transmissions, observed power levels, waveforms of signals, a type of radio access technology (RAT), a location, and time of transmissions.

In some embodiments, the plurality of wireless network nodes may identify one or more high priority devices. For example, the wireless network nodes may identify a high priority device based on one or more signal characteristics of a received RF signal. As another example, the wireless network nodes may identify high priority devices using information from a database or another listing of high priority devices (e.g., the Spectrum Access System (SAS) database). As another example, the wireless network nodes may be configured with information (e.g., in a memory) to identify high priority devices in a particular geographic area.

Based on the RF spectrum usage, one or more wireless network nodes may determine a maximum RF interference threshold of one or more high priority devices. In some embodiments, a wireless network node may determine the maximum RF interference threshold of a high priority device based on the spectrum usage and identification of the high priority device.

Using the maximum RF interference threshold of the one or more high priority devices, one or more wireless network nodes may calculate a transmit power level for use by one or more of the plurality of wireless network nodes that will avoid interfering with the one or more high priority devices. In some embodiments, each wireless network node may calculate its own respective transmit power level. The calculated transmit power for use by one or more of the plurality of wireless network nodes may be less than a maximum transmit power that would avoid interfering with the one or more high priority devices. The one or more wireless network nodes may then transmit RF signals using selected frequencies at or below the calculated transmit power level. The transmit power that is used by any one of the plurality of wireless network nodes may be less than the calculated transmit power and may also be based on other factors, such as maximum transmit capability of the wireless network node, a power level required to accomplish a given communication, a transmit power negotiated with an adjoining wireless network node, power-saving considerations, and regulatory restrictions.

In some embodiments, one of the plurality of wireless network nodes may act as a master or network coordinator to process information received from one or more other wireless network nodes to determine acceptable frequency sharing usages, and may assign a frequency/channel and calculate a transmit power level to the one or more other wireless network nodes. For example, the wireless network nodes may broadcast or narrowcast to one or more other wireless network nodes information summarizing the spectrum usage, signal characteristics, maximum RF interference threshold of one or more high priority devices, and/or a location of the wireless network node. This information may enable the master or network coordinator to determine acceptable frequency sharing usages and transmit power levels for the one or more other wireless network nodes. the master or network coordinator may then share the determined frequencies and transmit power levels with the one or more other wireless network nodes.

In some embodiments, frequency/channel selection and transmit power level calculations may be decentralized and distributed among the plurality of wireless network nodes. In such embodiments, each wireless network node may receive spectrum usage information, signal characteristic information, maximum RF interference threshold information of one or more high priority devices, and/or the location of each wireless network node (which may be determined or stored in memory during an installation procedure, for example). Each wireless network node may use the received information to determine frequencies/channels and to calculate a transmit power level that the wireless network node may use for transmissions without causing interference with a higher tier device.

In some embodiments, one or more of the wireless network nodes may transmit a signal at or below its respective calculated transmit power. In some embodiments, one or more wireless network nodes may select from among the one or more wireless network nodes to transmit based on each wireless network node's calculated transmit power. In some embodiments, one or more of the plurality of network nodes may be selected to transmit based on the RF spectrum usage and the maximum RF interference threshold of the one or more high priority devices. For example, one or more of the wireless network nodes may determine a receiver sensitivity of one or more of the wireless network nodes. Based on the receiver sensitivity of the one or more wireless network nodes, one or more wireless network nodes whose transmit power will enable signals to be received by another wireless network node may be identified. In some embodiments, the identified one or more wireless network nodes may be selected to transmit. In some embodiments, one or more of the plurality of network nodes may be directed to or may self determine to not transmit based on the RF spectrum usage map and the RF interference threshold of the one or more high priority devices.

Thus, one or more wireless network nodes may use the RF spectrum usage and the maximum RF interference threshold of the one or more high priority devices to control transmissions by one or more wireless network nodes at a granular level. In some embodiments, one or more of the plurality of wireless network nodes may transmit an RF signal at the calculated transmit power and at a time coincident with a transmission from one or more high priority devices. Thus by using the calculated transmit power, lower priority wireless network node(s) may transmit RF signals without interfering with high priority devices because the transmitted RF signals remain below the determined RF maximum interference threshold of the high priority devices.

The various embodiments enable wireless network nodes to make rapid, accurate decisions about spectrum usage/sharing based on detailed local spectrum usage information obtained by a plurality of wireless network nodes and shared across the network. Generation and use of such detailed information enables a more accurate determination of the available time, power level and space usage of the RF spectrum. Thus, the various embodiments may increase overall network capacity by more efficiently using the available RF spectrum.

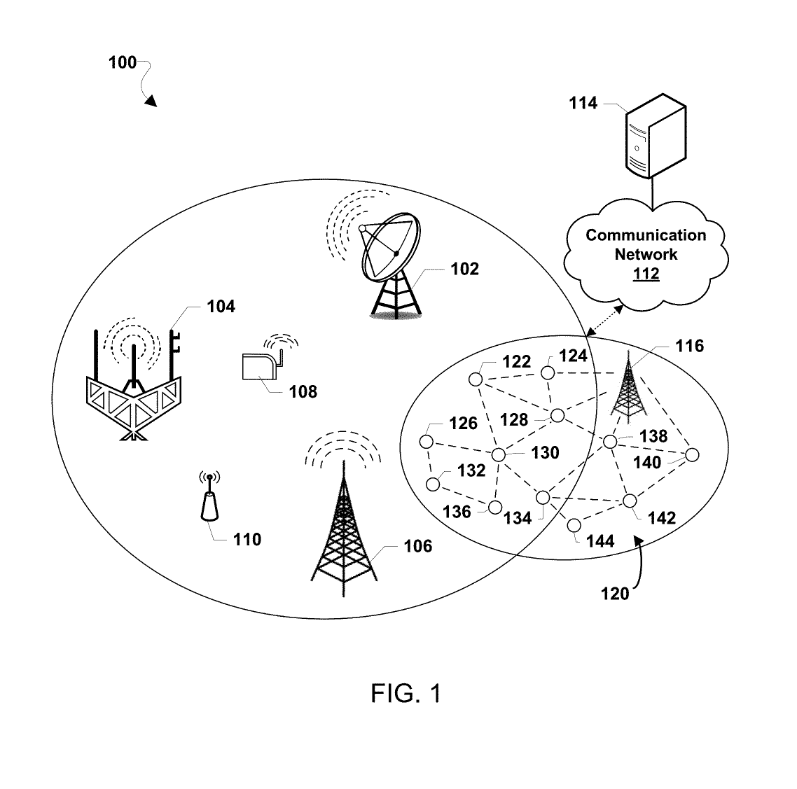

Various embodiments may be implemented in one or more wireless network nodes that may operate within a variety of communication environments, an example of which is illustrated in FIG. 1. A communication environment 100 may include a plurality of high priority devices, such as a satellite communication system 102, a radar system 104, a base station 106, a small cell 108, and a wireless access point 110, which transmit and receive RF signals that propagate through the communication environment 100.

The base station 106 may include a cellular network base station. The small cell 108 may include a micro cell, a pico cell, a femto cell, or another small cell of a communication network. The base station 106 and the small cell 108 may use one or more radio access technologies (RATs), including a 3G, 4G, and/or 5G cellular RAT, Wi-Fi or another short range RAT, LTE-U, LAA, MuLTEfire, and other RATs. The wireless access point 110 may use a short range RAT such as Wi-Fi, Bluetooth, or another short range RAT.

Each high priority device includes an RF receiver component to receive RF signals. As examples, the satellite communication system 102 may include an RF receiver and transmitter components to receive and transmit signals from one or more communication satellites, the radar system 104 may include an RF receiver and transmitter components to receive and transmit one or more radar signals, and the base station 106 may include an RF receiver and transmitter components to receive and transmit one or more cellular communication signals. The small cell 108 and the wireless access point 110 may similarly include RF receiver and transmitter components as well. The RF receiver and transmitter components of each high priority device may have a minimum RF signal sensitivity, and each RF receiver component may not detect an RF interference signal having a signal power level below that device's minimum RF signal sensitivity.

The communication environment 100 may also include a plurality of wireless network nodes 120, such as wireless network nodes 122-144. Each wireless network node 122-144 may communication with at least one other wireless network node 122-144, such that the wireless network nodes 120 may function as a mesh network. In some embodiments, the wireless network nodes 120 may function as an IoT mesh network. As such, in some embodiments, the wireless network nodes 120 may be participants in a massively distributed computing network. Each wireless network node 122-144 may communicate over one or more wireless communication links (illustrated with dashed lines). Each wireless network node 122-144 may also communicate with a wireless network base station 116 over one or more wireless communication links. The wireless network base station 116 may provide access to a communication network 112 for the wireless network nodes 112-144 either through direct communication with the wireless network base station or indirectly (e.g., “daisy chained”) through one or more of the wireless network nodes 122-144. In some embodiments, one of the wireless network nodes 122-144 may be selected to function as a master node capable of issuing instructions to one or more other wireless network nodes. In some embodiments, the wireless network nodes 122-144 may communicate with a server 114 (e.g., via the communication network 112). The server 114 may function as a master network element for a mesh network of the wireless network nodes 120, and may issue instructions to one or more of the wireless network nodes 122-144.

The wireless communication links may include a plurality of carrier signals, frequencies, or frequency bands, each of which may include a plurality of logical channels. In some embodiments, the communication links may use a wireless communication protocol such as an IoT communication protocol. An IoT communication protocol may include LTE Machine-Type Communication (LTE MTC), Narrow Band LTE (NB-LTE), Cellular IoT (CIoT), Narrow Band IoT (NB-IoT), BT Smart, Bluetooth Low Energy (BT-LE), Institute of Electrical and Electronics Engineers (IEEE) 802.15.4, and extended range wide area physical layer interfaces (PHYs) such as Random Phase Multiple Access (RPMA), Ultra Narrow Band (UNB), Low Power Long Range (LoRa), Low Power Long Range Wide Area Network (LoRaWAN), and Weightless. In some embodiments, the frequencies may be in the 3.5 GHz band. Each of the wireless communication links may utilize one or more RATs. In some embodiments, the communication links may use a wireless communication protocol such as a RAT in the Institute of Electrical and Electronics Engineers (IEEE) 802 family (including Wi-Fi, ZigBee, Bluetooth, and others). The communication links may include cellular communication links using 3GPP Long Term Evolution (LTE), (Global System for Mobility) GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies.

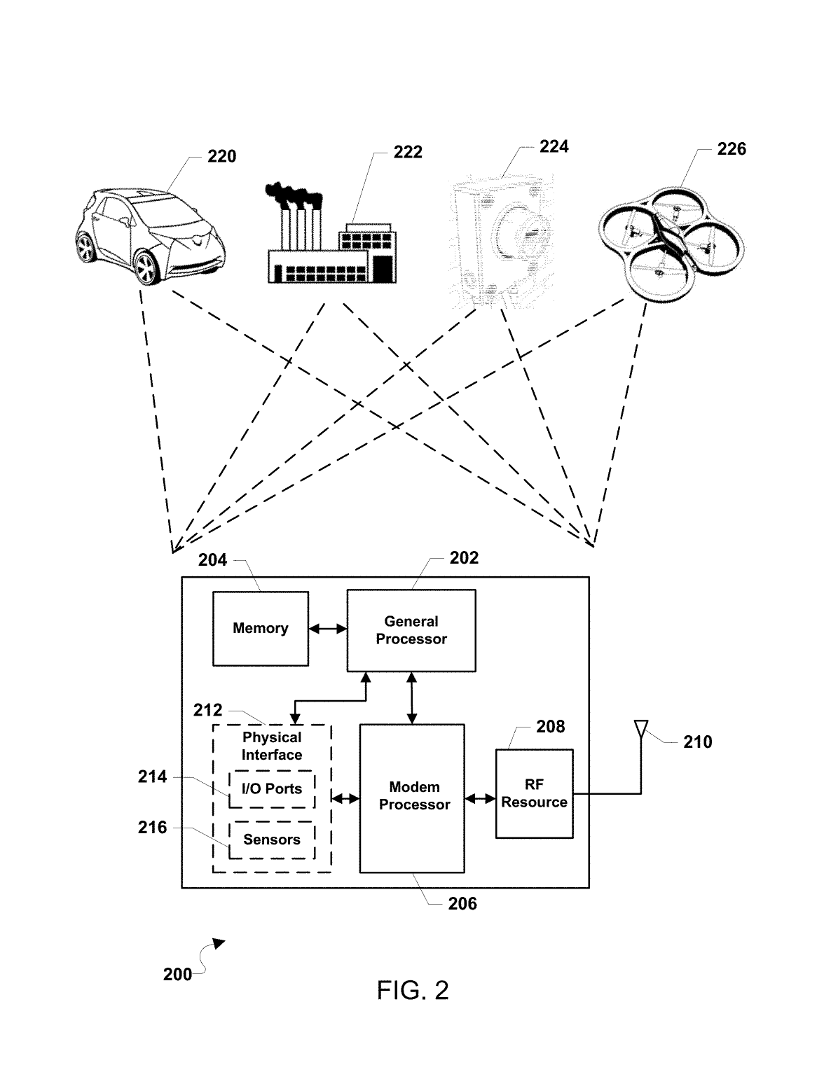

FIG. 2 is a component block diagram of a wireless network node 200 suitable for implementing various embodiments. With reference to FIGS. 1 and 2, in various embodiments, the wireless network node 200 may be similar to the wireless network nodes 122-144. Examples of types of devices including the wireless network node 200 include wireless access points supporting local wireless networks and smart appliances communicating with wireless networks, including televisions, set top boxes, kitchen appliances, lights and lighting systems, smart electricity meters, air conditioning/HVAC systems, thermostats, building security systems, doors and windows, door and window locks, building diagnostic and monitoring systems, and other devices. A wireless network node 200 may also be in communication with, or coupled to, a system, device, or structure. Non-limiting examples of devices/systems that may be configured with or to function as wireless network nodes include an automobile 220, a factory 222, smart meters 224, and unmanned aerial vehicles (such as a “drone”) 226.

The wireless network node 200 may include at least one processor, such as a general processor 202, which may be coupled to at least one memory 204. The memory 204 may be a non-transitory computer-readable storage medium that stores processor-executable instructions. The memory 204 may store an operating system, user application software, and/or other executable instructions. The memory 204 may also store application data, such as an array data structure. The memory 204 may include one or more caches, read only memory (ROM), random access memory (RAM), electrically erasable programmable ROM (EEPROM), static RAM (SRAM), dynamic RAM (DRAM), or other types of memory. The general processor 202 may read and write information to and from the memory 204. The memory 204 may also store instructions associated with one or more protocol stacks. A protocol stack generally includes computer executable instructions to enable communication using a radio access protocol or communication protocol.

The processor 202 and the memory 204 may communicate with at least one modem processor 206. The modem processor 206 may perform modem functions for communications with one or more other wireless network nodes, access points, base stations, and other such devices. The modem processor 206 may be coupled to an RF resource 208. The RF resource 208 may include various circuitry and components to enable the sending, receiving, and processing of radio signals, such as a modulator/demodulator component, a power amplifier, a gain stage, a digital signal processor (DSP), a signal amplifier, a filter, and other such components. The RF resource 208 may be coupled to a wireless antenna (e.g., a wireless antenna 210). The wireless network node 200 may include additional RF resources and/or antennas without limitation. The RF resource 208 may be configured to provide communications using one or more frequency bands via the antenna 210.

In some embodiments, the processor 202 may also communicate with a physical interface 212 configured to enable a wired connection to another device. The physical interface 212 may include one or more input/output (I/O) ports 214 configured to enable communications with the device to which the wireless network node is connected. The physical interface 212 may also include one or more sensors 216 to enable the wireless network node to detect information about a device with which the wireless network node 200 is connected via the physical interface 212. Examples of devices with which the wireless network node may be connected include smart appliances including televisions, set top boxes, kitchen appliances, lights and lighting systems, smart electricity meters, air conditioning/HVAC systems, thermostats, building security systems, doors and windows, door and window locks, building diagnostic and monitoring systems, and other devices.

The wireless network node 200 may also include a bus for connecting the various components of the wireless network node 200 together, as well as hardware and/or software interfaces to enable communication among the various components. The wireless network node 200 may also include various other components not illustrated in FIG. 2. For example, the wireless network node 200 may include a number of input, output, and processing components such as buttons, lights, switches, antennas, display screen or touchscreen, various connection ports, additional processors or integrated circuits, and many other components.

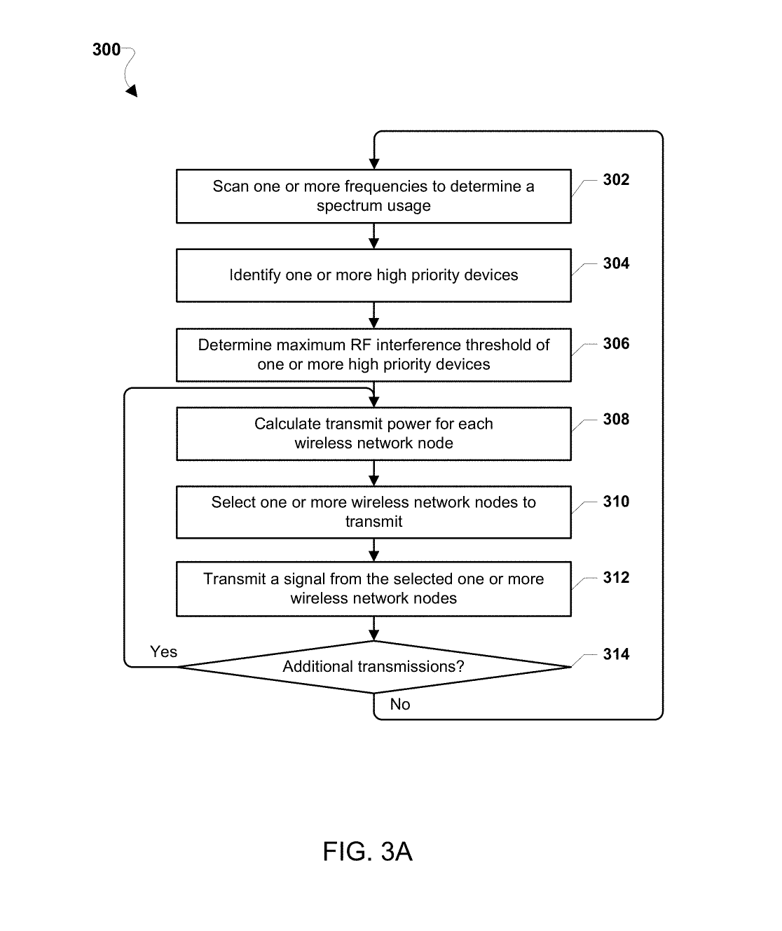

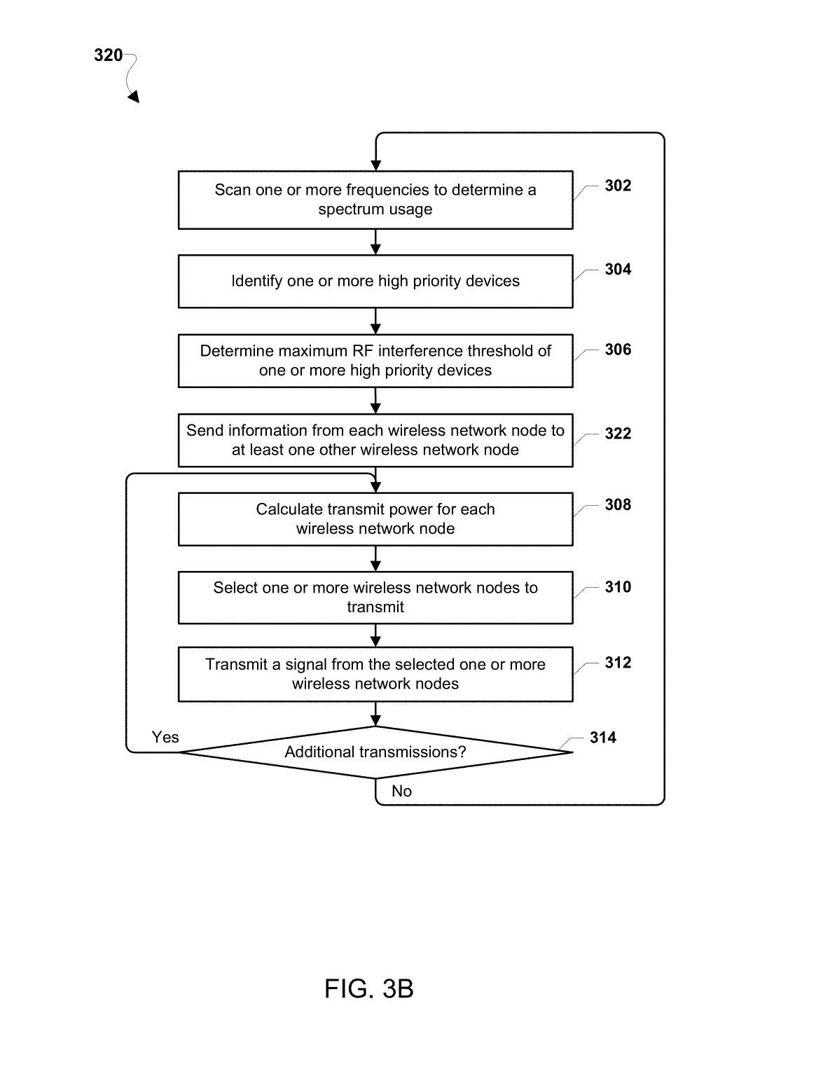

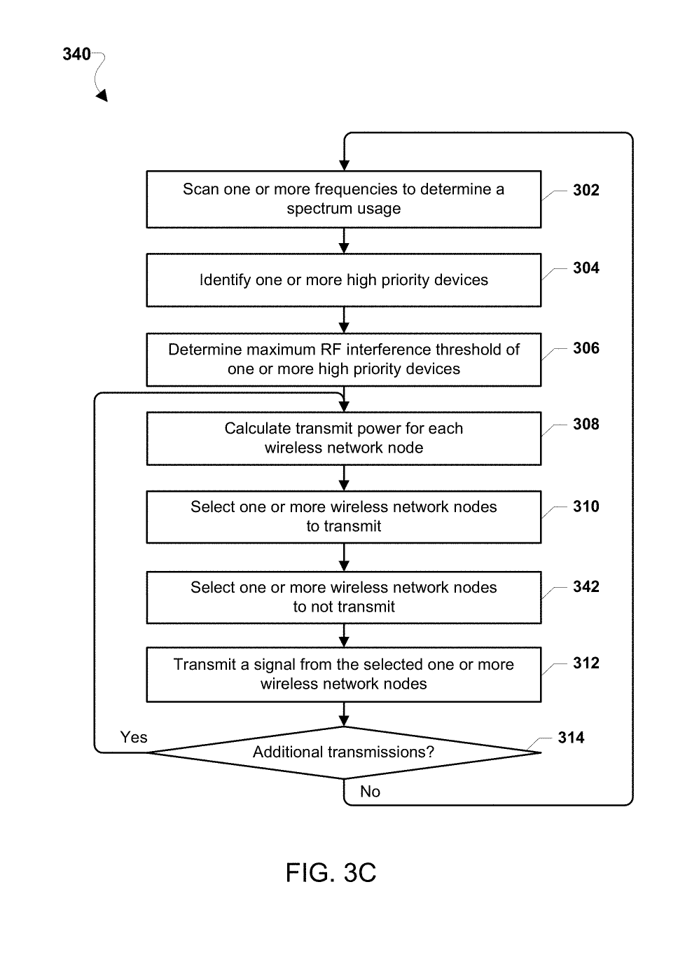

FIG. 3A is a process flow diagram illustrating a method 300 for managing RF spectrum usage by a wireless network node according to some embodiments. With reference to FIGS. 1-3A, the method 300 may be implemented by a processor (e.g., the general processor 202 or another similar processor) of a wireless network node (e.g., the wireless network nodes 122-144 and 200).

In block 302, the processor of one or more of a plurality of wireless network nodes (each a “device processor”) may scan one or more frequencies to determine a spectrum usage. In some embodiments, the processor may scan one or more channels in one or more frequencies to determine a spectrum usage. The plurality of wireless network nodes may be distributed over a geographic area, and each wireless network node may receive one or more signals from high priority devices. In some embodiments, each wireless network node may scan for one or more signals from one or more high priority devices in one or more frequencies over time. For example, a wireless network node may scan for one or more signals in a range of frequencies, such as the 3.5 GHz band or another frequency band, or another range of frequencies. Each of the plurality of wireless network nodes may periodically re-scan for one or more signals from high priority devices in one or more frequencies over time. The scanning may be performed dynamically in order to detect changes in the RF environment, such as due to wireless network nodes powering on or off, device mobility, RF and channel conditions, and other changes.

In some embodiments, scanning the one or more frequencies by the device processor may include measuring a received power of a signal of one or more high priority devices. In some embodiments, scanning the one or more frequencies may include determining one or more other signal characteristics of a signal of one or more scanned frequencies. Other signal characteristics may include, for example, a signal waveform, a center frequency of the signal, a signal bandwidth, a signal timing (e.g., an epoch or duration), a modulation type, a pilot channel, and/or a pilot frequency. Other signal characteristics may include a preamble structure, data in a preamble, a data format, and/or structure of a payload (e.g., a non-preamble portion) of the signal. In some embodiments, the device processor of each of the plurality of wireless network nodes may process the received signal power and/or other signal characteristics on an individual basis (e.g., using distributed processing as opposed to centralized processing of the signals and/or signal information). In some embodiments, the spectrum usage may include the received signal power and/or other signal characteristics.

In some embodiments, based on one or more received signals, each device processor may determine a frequency usage, one or more received power levels or signal strengths, and/or one or more times when the frequency is used in the geographic location of the respective wireless network node. In some embodiments, each device processor may sense and measure wireless spectrum usage across one or more target frequency bands (e.g., one or more IoT frequency bands), which may include frequencies used and observed power level(s) at its location.

In block 304, the device processor of one or more of the plurality of wireless network nodes may identify one or more high priority devices. For example, the wireless network nodes may identify a high priority device based on one or more signal characteristics of a received RF signal. As another example, the wireless network nodes may identify high priority device using information from a database or another listing of high priority devices (e.g., the Spectrum Access System (SAS) database). As another example, the wireless network nodes may be configured with information (e.g., in a memory) to identify high priority devices in a particular geographic area.

In some embodiments, identifying a high priority device may include identifying one or more characteristics of the high priority device. For example, the high priority device may have a minimum certified receiver sensitivity performance, a maximum noise figure, and a minimum required demodulation signal-to-noise ratio. In some embodiments, such information may be specific to a particular radio access technology.

In some embodiments, the each device processor may sense and measure wireless spectrum usage across one or more channels within one or more frequency bands.

In some embodiments, the device processor may identify high priority devices specifically, or generally as a type of high priority device. For example, the device processor may detect a Wi-Fi or cellular RAT preamble, in which case the device processor may identify a high priority device as a network access point, a cellular small cell, a cellular base station (e.g., a macro cell), or another similar transmitter based on the RAT preamble detected in the received signal. As another example, the device processor may detect one or more signal characteristics such as a signal waveform, a center frequency of the signal, a signal bandwidth, a signal timing (e.g., an epoch or duration), a modulation type, a pilot channel or frequency, and other signal characteristics that may enable the device processor to identify (specifically or generally) the high priority device emitting the signals.

As another example, the device processor may identify a radar signal or a satellite communication signal of a high priority device by partially decoding data in the signal, or by preamble detection, or by a combination thereof In some embodiments, the device processor may be configured with information to identify a high priority device by matching such information with one or more portions of the received signal (e.g., a preamble structure, data in a preamble, a data format or structure of a payload (e.g., a non-preamble portion) of the signal, or another portion of the received signal). As another example, the device processor may be configured with information to identify known high priority devices in a particular geographic area, or the device processor may access a database or another listing of high priority devices (e.g., the Spectrum Access System (SAS) database). In some embodiments, the device processor may identify a tier of a high priority device, such as a first or Incumbent User tier (e.g., a radar or satellite communication system) or second or Priority Access Level tier (e.g., a network access point, a cellular small cell, a cellular base station, etc.).

In block 306, the device processor of one or more of the plurality of wireless network nodes may determine a maximum RF interference threshold of the identified one or more high priority devices.

In some embodiments, a high priority device may broadcast information including a maximum RF interference threshold of the high priority device, and a device processor may determine the maximum RF interference threshold of such high priority device from the broadcast information. In some embodiments, a device processor may determine a maximum RF interference threshold of a high priority device by consulting a database, such as the SAS database.

In some embodiments, a device processor may determine a maximum RF interference threshold of a high priority device based on operation of the high priority device. For example, a device processor may determine the maximum RF interference threshold of a high priority device based on the spectrum usage and the identification of the high priority device. In some embodiments, the device processor may determine the maximum RF interference threshold of the high priority device based on the spectrum usage and one or more of the minimum certified receiver sensitivity performance, the maximum noise figure, and the minimum required demodulation signal-to-noise ratio of the high priority device.

In some embodiments, the maximum RF interference threshold may be represented as Iₘₐₓ, which may be calculated as a difference of a total noise and a thermal noise power (e.g., Iₘₐₓ=total noise−thermal noise power). The total noise may be determined as a ratio of a received signal power of a signal from a high priority device to a signal-to-noise ratio of the signal. The thermal noise power (e.g., which may be represented in decibels (dB)) may be determined as a relationship between a noise figure of the high priority device's receiver plus a noise power of the high priority device, where the noise power is kTB (where k represents Boltzmann's constant, T represents temperature, and B represents a noise bandwidth of the high priority device receiver.)

In block 308, the device processor of one or more of the plurality of wireless network nodes may calculate a transmit power for each wireless network node. In some embodiments, a device processor may calculate the transmit power based on the spectrum usage and the determined maximum RF interference threshold of one or more high priority devices. In some embodiments, a device processor may calculate the transmit power based on the measured spectrum usage, the one or more other signal characteristics, and the determined maximum RF interference threshold of the one or more high priority devices.

In some embodiments, the device processor of one or more of the plurality of wireless network nodes may calculate the transmit power level such that a transmission from each wireless network node using the calculated transmit power will not interfere with signal transmission or reception by one or more high priority devices. In some embodiments, a device processor may calculate the transmit power level such that a signal transmitted from the wireless network node will be below a high priority device's maximum RF interference threshold when the transmitted signal arrives at the high priority device. The transmit power calculated in block 308 for use by one or more of the plurality of wireless network nodes may be less than the maximum transmit power that will avoid interfering with the one or more high priority devices. In some embodiments, a wireless network node may calculate a transmit power level that is a minimum amount below the maximum RF interference threshold of the high priority device. In some embodiments, the calculated transmit power level may include a transmit power backoff for a transmit power reduction from a typical, normal, or standard transmit power.

As part of the operations in block 308, the device processor of one or more of the plurality of wireless network nodes may use information that is beyond the immediate detection range (e.g., beyond a sensing range) of the wireless network node. For example, the processor of a first wireless network node may calculate a transmit power that is below the maximum RF interference threshold of a high priority device that is detected by a second wireless network node. As part of the operations in block 308, a device processor may calculate the transmit power based on the attenuation of the first wireless network nodes signal strength as well as the maximum RF interference threshold of the high priority device as may be determined by the second wireless network node. In various embodiments, a server (e.g., the server 114 in FIG. 1) may function as a network-based coordinator of transmit power level and/or frequency/channel selection for one or more of the plurality of wireless network nodes.

As part of the operations in block 308 in various embodiments, the device processor of one or more of the plurality of wireless network nodes may also select a transmit frequency and/or channel that is a sufficient minimum separation (e.g., a threshold level separation) from the high priority device's transmit frequency and/or channel In some embodiments, the wireless network node may be configured to utilize beamforming, and the device processor may also select a directivity (e.g., a direction of transmission) based on the RF spectrum usage and or the determined maximum RF interference threshold, as part of the operations in block 308.

In block 310, the device processor of one or more of the plurality of wireless network nodes may select one or more wireless network nodes that may transmit. In some embodiments, the selection of the one or more wireless network nodes that may transmit may be based on the calculated transmit power level for the one or more wireless network nodes and the determined maximum RF interference threshold.

In block 312, the device processor of the selected one or more wireless network nodes may transmit a signal using identified frequencies at or below the calculated transmit power level. The transmit power used by any one of the selected wireless network nodes may be less than the calculated transmit power level determined in block 308 based on other factors, such as maximum transmit capability of the wireless network node, a power level required to accomplish a given communication, a transmit power negotiated with an adjoining wireless network node, power-saving considerations, and regulatory restrictions.

In some embodiments, in addition to transmitting at the calculated transmit power, the device processor may transmit at a frequency channel other than the frequency channel of the one or more high priority devices, and/or may transmit at a time other than an anticipated transmission time by the one or more high priority devices. By so doing, the device processor may increase the efficiency with which RF spectrum is shared concurrently with the one or more higher-priority devices.

In determination block 314, the device processor of the selected one or more wireless network nodes may determine whether there any additional transmissions to be made by the selected wireless network nodes.

In response to determining that there are additional transmissions to be made from the selected wireless network nodes (i.e., determination block 314=“Yes”), the device processors may recalculate transmit power levels for the wireless network nodes in block 308.

In response to determining that there are no additional transmissions to be made from the selected wireless network nodes (i.e., determination block 314=“No”), the device processor of one or more of the plurality of wireless network nodes may again scan one or more frequencies in block 302. The scanning may be performed dynamically in order to detect changes in the RF environment, such as due to wireless network nodes powering on or off, device mobility, RF and channel conditions, and other changes.

FIG. 3B is a process flow diagram illustrating a method 320 for managing RF spectrum usage by a wireless network node according to some embodiments. With reference to FIGS. 1-3B, the method 320 may be implemented by a processor (e.g., the general processor 202 or another similar processor) of a wireless network node (e.g., the wireless network nodes 122-144 and 200). In blocks 302-314, the device processor may perform operations of like numbered blocks of the method 300 described with reference to FIG. 3A.

In block 322, the processor of one or more of the plurality of wireless network nodes may send information to at least one other wireless network node. The information may include the spectrum usage and/or the identification of the one or more high priority devices.

In some embodiments, the processor of one wireless network node may send to one or more other wireless network nodes the spectrum usage and/or, the identification of the one or more high priority devices. For example, the processor may send the information that the processor has determined about the wireless network node's RF environment (e.g., the spectrum usage and/or the identification of the one or more high priority devices) to one or more other wireless network nodes. In some embodiments, the processor may send the information to a wireless network base station (e.g., the wireless network base station 116), either through direct communication with the wireless network base station (via wired or wireless networks) or indirectly (e.g., “daisy chained”) through another one or more of the wireless network nodes. In some embodiments, the processor may send the information to a server (e.g., the server 114) via the communication network 112, the wireless network base station 116, or via another of the wireless network nodes.

FIG. 3C is a process flow diagram illustrating a method 340 for managing RF spectrum usage by a wireless network node according to some embodiments. With reference to FIGS. 1-3C, the method 340 may be implemented by a processor (e.g., the general processor 202 or another similar processor) of a wireless network node (e.g., the wireless network nodes 122-144 and 200). In blocks 302-314, the device processor may perform operations of like numbered blocks of the method 300 as described with reference to FIG. 3A.

In block 342, the processor of one or more of the plurality of wireless network nodes may select one or more wireless network nodes to not transmit. For example, a first wireless network node (e.g., the wireless network node 122) may be selected (e.g., may be self-selected, or selected by a server or by another wireless network node) to not transmit because of its proximity to a high priority device (e.g., the satellite communication system 102). For example, because of the proximity of wireless network node 122 to a satellite communications system 102, the calculated transmit power for the wireless network node may be so low (e.g., below a transmit power level threshold) that transmissions by the first wireless network node using its transmit power will not be received by another wireless network node. Continuing the example, a second wireless network node (e.g., the wireless network node 126) may be selected to transmit (e.g., in block 310) because the calculated transmit power for the second wireless network node is sufficiently high (e.g., above a transmit power level threshold) that signals transmitted at that power from the second wireless network node can be received by another wireless network node.

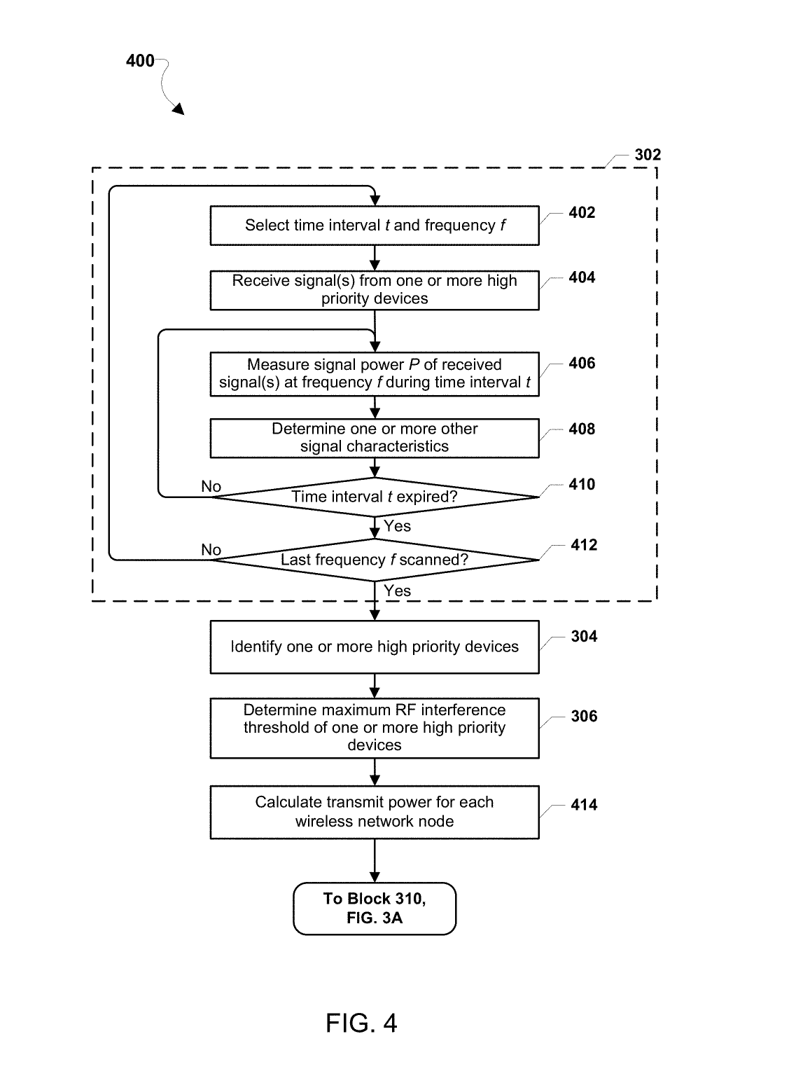

FIG. 4 is a process flow diagram illustrating a method 400 for managing RF spectrum usage by a wireless network node according to some embodiments. With reference to FIGS. 1-4, the method 400 may be implemented by a processor (e.g., the general processor 202 or another similar processor) of a wireless network node (e.g., the wireless network nodes 122-144 and 200).

The operations of blocks 402-412 provide an example of operations that may be involved in block 302 of the methods 300, 320 and 340 described above with reference to FIGS. 3A-3C.

In block 402, the processor of one or more of the plurality of wireless network nodes may select a time interval and a frequency to scan. For ease of reference, the time interval is represented as t, and the frequency is represented as f The selected frequency may include a range of frequencies or a band of frequencies. The selected frequency may also include one or more channels.

In block 404, the processor of the one or more of the plurality of wireless network nodes may receive one or more signals from one or more high priority devices while scanning the selected frequency or frequencies.

In block 406, the processor of the one or more of the plurality of wireless network nodes may measure a signal power of a signal received while scanning the selected frequency or frequencies during the time interval. In some embodiments, the processor may determine the received signal power as a function of the transmit power of the transmitting high priority device minus signal losses incurred before reception of the signal by the processor of the wireless network node.

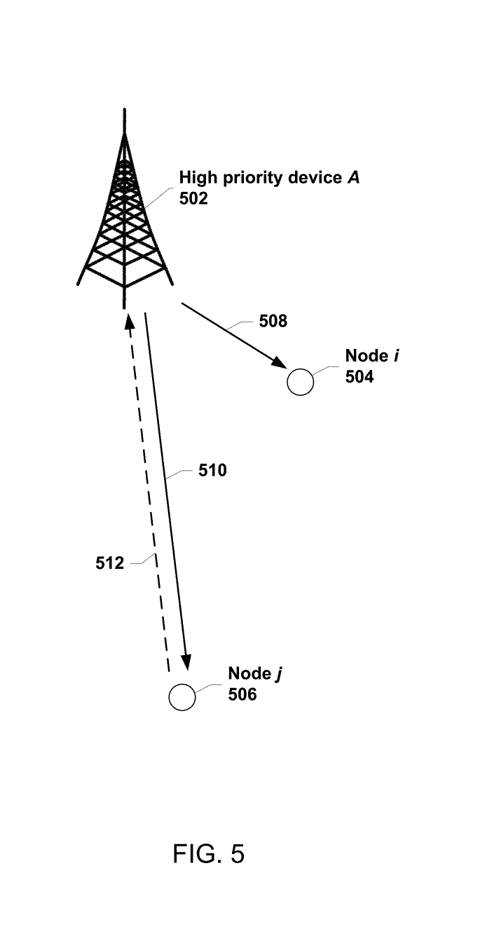

For example, with reference to FIG. 5, a wireless network node i 504 and a wireless network node j 506 may each receive a signal transmitted by a high priority device A 502. Wireless network node i 504 may receive signal 508, and wireless network node j 506 may receive signal 510. In some embodiments, the high priority device A 502 may transmit an indication of its transmit power level. In some embodiments, the wireless network node i 504 and the wireless network node j 506 may obtain the transmit power level of the high priority device A 502 from a database, or from information provisioned in a memory of each wireless network node.

In some embodiments, the processor of one or more wireless network nodes may determine incurred signal losses based on the determined transmit power level of the high priority device A 502 and the measured signal power of the received signal. For example, the received signal power measured by wireless network node i 504 may be represented as:

P_{RX,j}=P_{TX,A}−L_{Ai},

where P_{RX,j} represents the received signal power measured by the wireless network node i 504, P_{TX,A} represents the transmit power level of the high priority device A 502, and L_{Ai} represents signal losses incurred by the signal 508 (i.e., from the high priority device A 502 to the wireless network node i 504).

Similarly, in some embodiments, the received signal power measured by wireless network node j 506 may be represented as:

P_{RX,j}=P_{TX,A}−L_{Aj},

where P_{RX,j} represents the received signal power measured by wireless network node j, P_{TX,A} represents the transmit power level of the high priority device A 502, and L_{Aj} represents signal losses incurred by the signal 510 (i.e., from the high priority device A 502 to the wireless network node j 506).

The incurred signal losses L_{Ai}, L_{Aj} may indicate characteristics of the RF environment, such as RF signal interference, geographical or topological signal effects, multipath interference, RF fading, RF shadowing, propagation delay and other environmental signal attenuation, and other characteristics of the RF environment. While the wireless network nodes i 504 and j 506 may measure the received signal power P_{RX,j} and P_{RX,j} respectively, the wireless network nodes i 504 and j 506 may be unable to determine the transmit power of the high priority device A 502 or the incurred signal losses from the received signal power alone. Thus, in some embodiments, each wireless network node may estimate the incurred signal losses (e.g., L_{Ai}, L_{Aj}). In some embodiments, the processor of the wireless network node i 504 may estimate L_{Ai} using a pilot signal or a similar signal that is transmitted by the high priority device A 502 (e.g., an embedded pilot) to estimate channel state information (CSI). The processor of the wireless network node j 506 may estimate L_{Aj} using a similar pilot signal or a similar signal transmitted by the high priority device A 502.

Additionally or alternatively, to facilitate the determination of incurred signal losses by one or more wireless network nodes in some implementations, a wireless network (e.g., the wireless network node i 504) may be placed in close proximity to the high priority device A 502 in order to detect the transmit power level of the high priority device A 502 (e.g., P_{TX,A}). In such implementations, the signal losses incurred by the signal 508 may be assumed to be minimal, and thus estimated to be zero for purposes of determining the transmit power level of the high priority device A 502. The wireless network node i 504 may send the detected transmit power level of the high priority device A 502, e.g., to the wireless network node j 506. The wireless network node j 506 may determine the incurred signal losses L_{A,j} using the transmit power level of the high priority device A 502 detected by the wireless network node i 504. Thus, the wireless network node j 506 may determine a value of the incurred signal losses L_{Aj} even if the wireless network node j 506 is unable to demodulate channel state information from the signals of the high priority device A 502.

Returning to FIG. 4, in block 408, the processor of the one or more of the plurality of wireless network nodes may determine one or more other signal characteristics. The one or more other signal characteristics may include periodicity or timing of operation, a waveform of the received signal, a RAT type, a location, a time, and other signal characteristics.

In determination block 410, the processor of the one or more of the plurality of wireless network nodes may determine whether the time interval t has expired. In response to determining that the time interval t has not expired (i.e., determination block 410=“No”), the processor may continue to measure the signal power of one or more received signals at the selected frequency during the time interval in block 402.

In response to determining that the time interval t has expired (i.e., determination block 410=“Yes”), the processor may determine whether the last frequency f has been scanned (i.e., whether other frequencies remain to be scanned) in determination block 412. In response to determining that the processor has not scanned the last frequency f (i.e., determination block 412=“No”), the processor may select another time interval t and frequency f in block 402.

In response to determining that the last frequency f has been scanned (i.e., determination block 412=“Yes”), the processor of the one or more of the plurality of wireless network nodes may identify one or more high priority devices in block 304 as described for the like numbered block for the method 300 with reference to FIG. 3A.

In block 306, the processor of the one or more of the plurality of wireless network nodes may determine a maximum RF interference threshold of one or more high priority devices as described for the like numbered block for the method 300 with reference to FIG. 3A.

In block 414, the processor of the one or more of the plurality of wireless network nodes may calculate a transmit power for a wireless network node. In some embodiments, the processor may use the received signal power to determine a transmit power for one or more wireless network nodes. For example, the processor may calculate a transmit power (which may be represented as P_{TX}) for a particular wireless network node so that a signal transmitted from that wireless network node is below the maximum RF interference threshold of a high priority device (e.g., Iₘₐₓ) when the transmitted signal arrives at the high priority device.

Referring to FIG. 5, for example, a transmit power of a signal 512 may be determined for the wireless network node j 506 such that signals 512 transmitted from the wireless network node j 506 are received at the high priority device A 502 with a signal power level that is less than the maximum RF interference threshold of the high priority device A 502, which may be represented as:

P_{RX,A}<I_{max,A},

where P_{RX,A} represents the signal power of the signal (e.g., the signal 512) received at the high priority device A 502, and Iₘₐₓ. A represents the maximum RF interference threshold of the high priority device A 502.

In some implementations, the processor may use the determined signal losses of signals received by one or more wireless network nodes to determine the transmit power of a wireless network node. The processor may determine the transmit power of the wireless network node j 506 as a function of the incurred signal loss of the signal 510, which may be represented as follows:

P_{RX,A}=P_{TX,j}−L_{jA}<I_{max,A}.

In some embodiments, the processor may also use the signal losses incurred by the signals 510 from the high priority device A 502 to the wireless network node j 506 (L_{Aj}) to calculate the transmit power for the wireless network node j 506, which may be represented as:

P_{RX,A}<I_{max,A},

where P_{RX,A} represents the signal power of the signals (e.g., the signals 512) received at the high priority device A 502. This may be equivalently represented as:

(P_{TX,j}−L_{jA})<I_{max,A},

where L_{jA} represents a signal loss incurred by the signals 512 from the wireless network node j 506 to the high priority device A 502.

In some embodiments, the processor may determine L_{jA} based on L_{Aj} by channel reciprocity. In other words, the processor may assume that the signal path loss from the high priority device j 506 to the high priority device A 502 will be equivalent to the calculated signal path loss from the high priority device A 502 to the high priority device j 506. As noted above, the processor of the wireless network node j 506 may estimate L_{Aj} using a pilot signal or a similar signal transmitted by the high priority device A 502. In some embodiments, the processor of the wireless network node j 506 may determine the incurred signal losses of the signals 510 (e.g., L_{Aj}) based on the received signal power of the signals 508 measured at the wireless network node 504 i (e.g., P_{RX,j}), assuming that the incurred signal losses of the signals 508 (e.g., L_{Ai}) are zero.

In some embodiments, the processor may calculate the transmit power of the wireless network node j 506 as a function of three variables: the maximum RF interference threshold of the high priority device A 502, the received signal power measured by wireless network node j 506 (P_{RX,j}), and the received signal power measured by wireless network node i 504 (P_{RX,j}), which may transmit power be represented as:

P_{TX,j}<I_{max,A}+P_{RX,ju}−P_{RXj}.

The processor of the one or more of the plurality of wireless network nodes may continue with the operations of the method 300 in block 310 as described with reference to FIG. 3A.

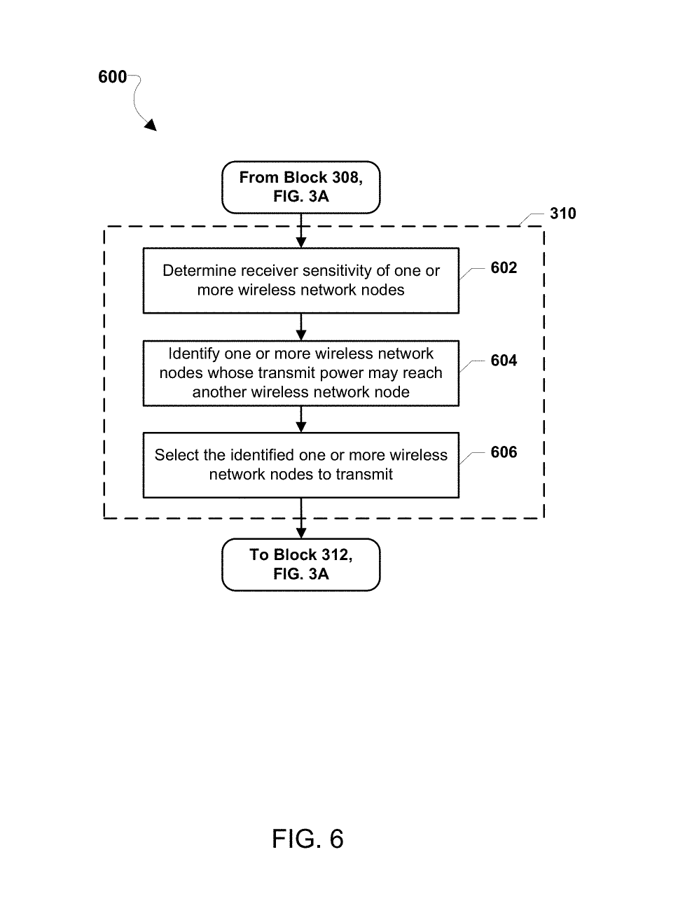

FIG. 6 is a process flow diagram illustrating a method 600 for selecting one or more wireless network nodes that may transmit according to some embodiments. With reference to FIGS. 1-6, the method 600 may be implemented by a processor (e.g., the general processor 202 or another similar processor) of a wireless network node (e.g., the wireless network nodes 122-144 and 200). The method 600 illustrates an example of operations that may be performed in block 310 of the method 300, 320, and 340 as described with reference to FIGS. 3A-3C.

In block 602, the processor of one or more of the plurality of wireless network nodes may determine a receiver sensitivity of one or more wireless network nodes. In some examples, the processor may receive an indication from another wireless network node of a receiver sensitivity of the other wireless network node. In other examples, the processor may obtain from a memory a receiver sensitivity of one or more other wireless network nodes.

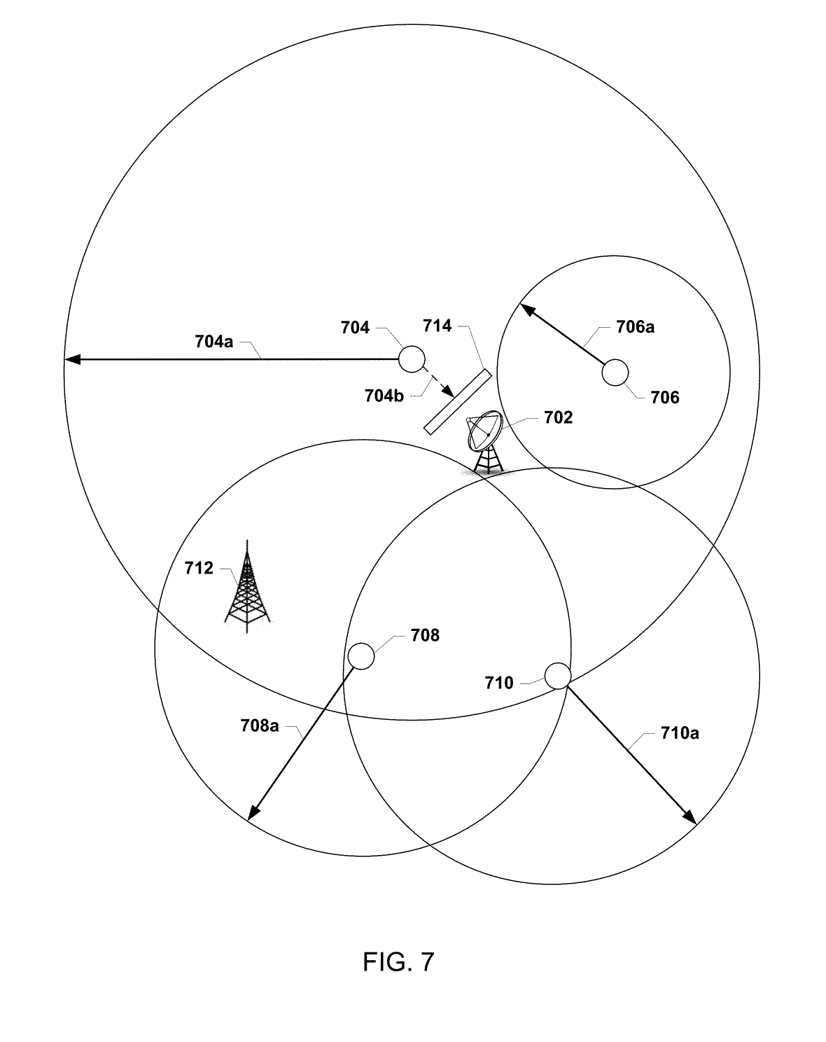

For example, referring to FIG. 7, a processor of one or more of the plurality of wireless network nodes 704, 706, 708, and 710 may determine a receiver sensitivity of one or more wireless network nodes. For example, the processor of the wireless network node 704 may determine a receiver sensitivity of one or more of wireless network nodes 706, 708, and 710, and so on.

Returning to FIG. 6, in block 604, the processor of one or more of the plurality of wireless network nodes may identify one or more wireless network nodes whose transmit power may reach another wireless network node.

For example, the wireless network nodes 704, 706, 708, and 710 illustrated in FIG. 7 may have a calculated transmit power that has been calculated so as not to interfere with high priority device 702, and which may reach an approximate radius 704a, 706a, 708a, and 710a, respectively. While wireless network node 704 may be relatively close to a high priority device 702, a characteristic of the RF environment 714 may prevent even a relatively high-power signal from the wireless network node 704 from interfering with the high priority device 702. The characteristic of the RF environment 714 may include an obstruction that causes RF shadowing, RF signal interference, or another aspect of the RF environment that may cause signal attenuation 704b such that a signal from the wireless network node 704 does not interfere with the high priority device 702. The transmit power 704a of the wireless network node 704 is large enough for a signal from the wireless network node 704 to reach the wireless network nodes 706, 708, and 710, as well as an IoT access point 712.

In contrast, because the wireless network node 706 is relatively close to the high priority device 702, the transmit power 706a of the wireless network node 706 is relatively low, and a signal from the wireless network node 706 cannot reach any of the wireless network nodes 704, 708, and 710. The transmit power 708a of the wireless network node 708 is large enough for a signal from the wireless network node 708 to reach both the wireless network node 710 and the IoT access point 712. The transmit power 710a of the wireless network node 710 is large enough for a signal from the wireless network node 710 to reach the wireless network node 708. In some implementations, the wireless network node 708 may relay a signal, e.g., from the wireless network node 710, to the IoT access point 712.

Thus, the processor of the one or more of the plurality of wireless network nodes (e.g., a processor of one or more of wireless network nodes 704, 706, 708, and 710) may identify one or more wireless network nodes whose transmit power may reach another wireless network node.

In some embodiments, the identified one or more wireless network nodes may be considered eligible to transmit a signal. For example, the processor of the one or more of the plurality of wireless network nodes may determine a subset of wireless network nodes that satisfy a requirement of having a transmit power that is greater than the receiver sensitivity of another wireless network node. This may be represented as:

P_{RX,j}>RX_{sens,k},

where P_{RX,jk} represents the received power of a signal transmitted from a transmitting wireless network node (e.g., one of the wireless network nodes 704, 706, 708, 710, represented here as j) and received by another wireless network node (e.g., another of the wireless network nodes 704,706, 708, 710, represented here as k), and where RX_{sens,k} represents the receiver sensitivity of the wireless network node k.

In some embodiments, the processor of the one or more of the plurality of wireless network nodes may identify the wireless network nodes eligible to transmit using an indicator function. A non-limiting example of such an indicator function is represented as:

$$\{ {j}^{*} \} = {argmax}_{j ∈ θ} \{ {𝕀}_{θ} 〈 ( {P}_{TX , j} - {L}_{jk} ) > {RX}_{sens , k} 〉 \} ,$$

where {j*} represents a set of wireless network nodes eligible to transmit, θ represents a set of all wireless network nodes, θ represents a subset of wireless network nodes that satisfy the requirement P_{RX,jk}>RX_{sens,k}Lⱼₖ represents an incurred signal loss of a signal transmitted from wireless network node j to wireless network node k, and I_{θ} represents the indicator function. Thus, the processor of the one or more of the plurality of wireless network nodes may identify the wireless network nodes j* that are elements of θ and that may transmit using their respective transmit powers without interfering with a high priority device (e.g., may co-exist with a high priority device, such as the high priority device 702). In some embodiments, a wireless network node may transmit a signal to another wireless network node. In some embodiments, network nodes may transmit a signal using a direct-hop transmission to the IoT base station 712, or a multi-hop transmission via one or more wireless network nodes to relay a signal to the IoT base station 712.

Returning to FIG. 6, in block 606, the processor of the one or more of the plurality of wireless network nodes may select the identified one or more wireless network nodes to transmit. For example, the processor of the wireless network node may select those wireless network nodes that are eligible to transmit a signal.

In some embodiments, the processor of the one or more of the plurality of wireless network nodes may select all of the wireless network nodes to transmit using their respective calculated transmit power. For example, every wireless network node may be selected, regardless of whether a signal from a wireless network node may reach another wireless network node (e.g., including the wireless network node 706). Each wireless network node may transmit with its calculated transmit power, flooding the network whether signals of each wireless network node reaches another node or not. However, transmissions from all available wireless network nodes may be less efficient than selecting certain wireless network nodes to transmit.

In some embodiments, a transmitting wireless network node may retransmit its signal in the absence of an acknowledgement message from wireless network nodes or another receiving device (e.g., an IoT base station, or another IoT entity). In such embodiments, if the signal of the transmitting wireless network node is received by a receiving device, then the receiving device may send an acknowledgment message to the transmitting node, such that the transmitting node may cease or prevent retransmissions.

The processor of the one or more of the plurality of wireless network nodes may continue with the operations of the method 300 at block 312 as described with reference to FIG. 3A.

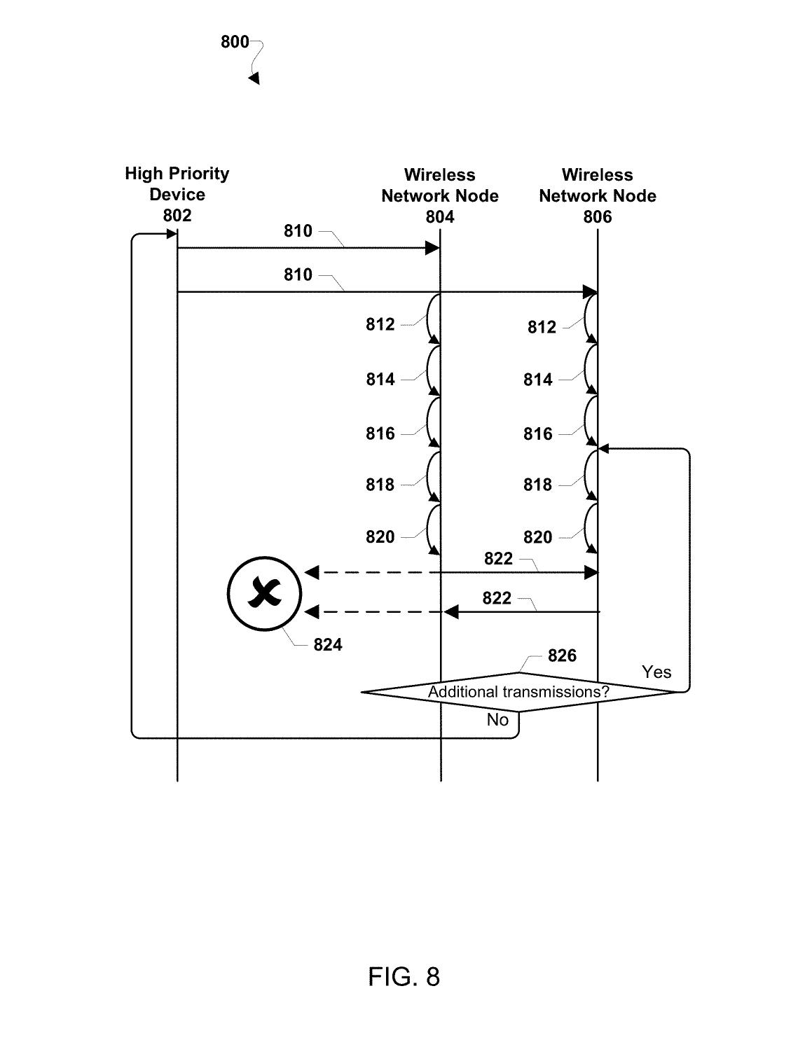

FIG. 8 is a message flow diagram illustrating communications and operations of a method 800 for managing resource frequency usage by a wireless network node according to some embodiments. With reference to FIGS. 1-8, the method 800 may be implemented by a processor (e.g., the general processor 202 or another similar processor) of a wireless network node (e.g., the wireless network nodes 122-144 and 200).

Wireless network nodes 804 and 806 (which may be similar to the wireless network nodes 122-144 and 200) may receive a signal 810 from a high priority device 802 (which may be similar to the high priority devices 102-110). Each wireless network node 804 and 806 may scan one or more frequencies to determine spectrum usage in operation 812. In some embodiments, each wireless network node may scan for one or more signals from high priority devices in one or more frequencies over time. Based on the scan, the processor of each wireless network node may determine a spectrum usage.

One or more of the wireless network nodes 804 and 806 may identify the high priority device 802 in operation 814. For example, the wireless network node(s) may identify a high priority device based on one or more signal characteristics of the received signal 810. One or more of the wireless network nodes 804 and 806 may also identify the high priority device 802 using information from a database or another listing of high priority devices. One or more of the wireless network nodes 804 and 806 may also be configured with information enabling the wireless network nodes 804 and 806 to identify the high priority device 802.

One or more of the wireless network nodes 804 and 806 may determine a maximum RF interference threshold of the high priority device 802 in operation 816. In some embodiments, one or more of the wireless network nodes 804 and 806 may determine the maximum RF interference threshold of the high priority device based on the spectrum usage and the identification of the high priority device 802.

One or more of the wireless network nodes 804 and 806 may calculate a transmit power in operation 818. In some embodiments, one or more of the wireless network nodes 804 and 806 may calculate the transmit power based on the spectrum usage and the determined maximum RF interference threshold the high priority device 802. In some embodiments, one or more of the wireless network nodes 804 and 806 may calculate the transmit power based on the spectrum usage, the one or more additional signal characteristics, and the determined maximum RF interference threshold of the high priority device 802. In some embodiments, one or more of the wireless network nodes 804 and 806 may calculate a transmit power level that is below the maximum RF interference threshold of the high priority device 802.

One or more of the wireless network nodes 804 and 806 may select one or more wireless network nodes that may transmit in operation 820. In some embodiments, the selection of the one or more wireless network nodes that may transmit may be based on the calculated transmit power level for the one or more wireless network nodes and the determined maximum RF interference threshold.

One or more of the wireless network nodes 804 and 806 may transmit a signal 822 to one or more of the other of the wireless network nodes 804 and 806. When transmitted at the calculated transmit power level, the transmit signal will not interfere 824 with the high priority device 802.

In some embodiments, one or more of the wireless network nodes 804 and 806 may determine whether there are any additional transmissions in operation 826. In response to determining that there are additional transmissions from the one or more wireless network nodes (i.e., determination block 826 =“Yes”), one or more of the wireless network nodes 804 and 806 may calculate a transmit power level in operation 818 for one or more wireless network nodes. In response to determining that there are no additional transmissions from the one or more wireless network nodes (i.e., determination block 826=“No”), one or more of the wireless network nodes 804 and 806 may again receive one or more signals 810 from the high priority device 802.

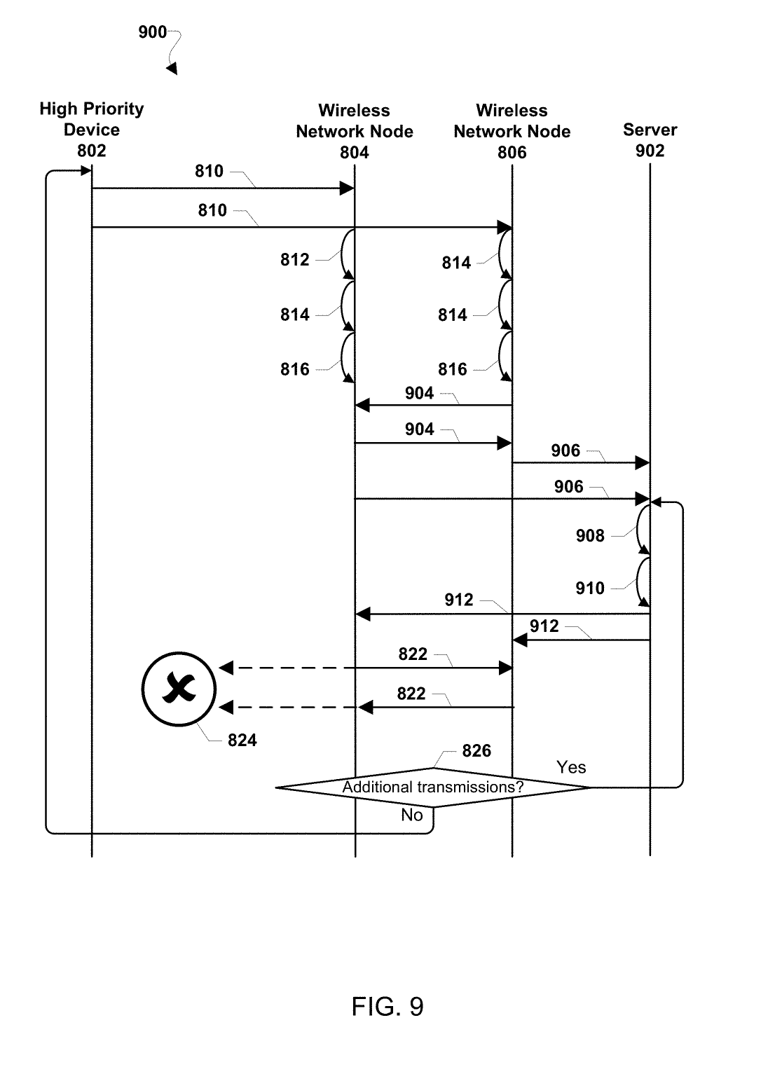

FIG. 9 is a message flow diagram illustrating communications and operations of a method 900 for managing resource frequency usage by a wireless network node according to some embodiments. With reference to FIGS. 1-9, the method 900 may be implemented by a processor (e.g., the general processor 202 or another similar processor) of a wireless network node (e.g., the wireless network nodes 122-144 and 200). In operations 802-826, the processor may perform operations of like numbered blocks of the method 800.

One or more of the wireless network nodes 804 and 806 may send information 904 to at least one other wireless network node. In some embodiments, the information may include the spectrum usage and/or the identification of the one or more high priority devices.

One or more of the wireless network nodes 804 and 806 may send information 906 to a server 902. In some embodiments, the information may include the spectrum usage and/or the identification of the one or more high priority devices.

The server 902 may calculate a transmit power level in operation 908 for one or more wireless network nodes. The server 902 may also select one or more of the wireless network nodes 804 and 806 to transmit in operation 910.

In some embodiments, the server 902 may act as a central node or master node, and may transmit instructions 912 to one or more of the wireless network nodes 804 and 806. For example, the server 902 may transmit instructions 912 to one or more of the wireless network nodes 804 and 806. The instructions 912 may include a calculated transmit power level and/or a selection of a wireless network node to transmit.

Thus, the one or more wireless network nodes (or a server) may make rapid, accurate decisions about spectrum usage/sharing using detailed local spectrum usage information obtained by one or more of the plurality of wireless network nodes. Further, the detailed spectrum usage information may be shared across a mesh network of the plurality of wireless network nodes. Overall network capacity may be increased, because the detailed spectrum usage information may enable a more accurate determination of available time, power level and space usage of the RF spectrum.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 300, 320, 340, 400, 600, and of the message flows 800 and 900 may be substituted for or combined with one or more operations of the methods 300, 320, 340, 400, 600, and the message flows 800 and 900.

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the spirit or scope of the embodiments. Thus, various embodiments are not intended to be limited to the embodiments shown herein but are to be accorded the widest scope consistent with the following claims and the principles and novel features disclosed herein.

What is claimed is:

1. A method of managing radio frequency (RF) spectrum usage by one or more wireless network nodes among a distributed plurality of wireless network nodes, comprising:
scanning one or more frequencies to determine spectrum usage;
identifying one or more high priority devices based on the scanning;
determining a maximum RF interference threshold of the identified one or more high priority devices based on the determined spectrum usage by the identified one or more high priority devices;
calculating a transmit power for one or more wireless network nodes based on the determined maximum RF interference threshold;
identifying as eligible to transmit a signal one or more wireless network nodes whose calculated transmit power is less than the determined maximum RF interference threshold and is greater than a receiver sensitivity of another of the wireless network nodes;
selecting from among the wireless network nodes that are eligible to transmit the signal one or more wireless network nodes to transmit based on the calculated transmit power of the one or more wireless network nodes; and
transmitting the signal from the selected one or more wireless network nodes at or below the calculated transmit power.

2. The method of claim 1, wherein scanning the one or more frequencies to determine spectrum usage comprises measuring a received power of a signal from the identified one or more high priority devices.

3. The method of claim 1, wherein scanning the one or more frequencies to determine spectrum usage comprises determining one or more other signal characteristics of a signal of the identified one or more high priority devices.

4. The method of claim 1, wherein scanning one or more frequencies to determine spectrum usage comprises:
selecting a time interval and a frequency for scanning;
measuring a signal power of a signal received from each of the identified one or more high priority devices; and
determining the maximum RF interference threshold of each of the identified one or more high priority devices based on the measured signal power of signals received from each of the identified one or more high priority devices.

5. The method of claim 1, further comprising:
sending information from each wireless network node to at least one other wireless network node.

6. The method of claim 1, wherein calculating a transmit power for one or more wireless network nodes based on the determined maximum RF interference threshold comprises:
determining a transmit power of each of the identified one or more high priority devices; and
calculating the transmit power for the one or more wireless network nodes based on the determined maximum RF interference threshold and the determined transmit power of each of the identified one or more high priority devices.

7. The method of claim 1, wherein calculating a transmit power for one or more wireless network nodes based on the determined maximum RF interference threshold of the identified one or more high priority devices comprises:
determining an incurred signal loss of a signal from the identified one or more high priority devices received at the one or more wireless network nodes;
determining a transmit power of each of the identified one or more high priority devices; and
calculating the transmit power for the one or more wireless network nodes based on the incurred signal loss and the determined transmit power of each of the identified one or more high priority devices.

8. The method of claim 7, wherein calculating the transmit power for one or more wireless network nodes based on the incurred signal loss and the determined transmit power of each of the identified one or more high priority devices comprises:
calculating the transmit power for the one or more wireless network nodes based on the incurred signal loss and the determined transmit power of the identified one or more high priority devices such that a signal transmitted at the calculated transmit power from the one or more wireless network nodes is estimated to arrive at the identified one or more high priority devices with a signal power that is less that the maximum RF interference threshold of the one or more high priority devices.

9-10. (canceled)

11. A wireless network node, comprising:
a processor configured with processor-executable instructions to perform operations comprising:
scanning one or more frequencies to determine spectrum usage;
identifying one or more high priority devices based on the scanning;
determining a maximum RF interference threshold of the identified one or more high priority devices based on the determined spectrum usage by the identified one or more high priority devices;
calculating a transmit power for one or more wireless network nodes based on the identifying as eligible to transmit a signal one or more wireless network nodes whose calculated transmit power is less than the determined maximum RF interference threshold and is greater than a receiver sensitivity of another of the wireless network nodes;
selecting from among the wireless network nodes that are eligible to transmit the signal one or more wireless network nodes to transmit based on the calculated transmit power of the one or more wireless network nodes; and
transmitting the signal from the selected one or more wireless network nodes at or below the calculated transmit power.

12. The wireless network node of claim 11, wherein the processor is configured with processor-executable instructions to perform operations such that scanning the one or more frequencies to determine spectrum usage comprises measuring a received power of a signal from the identified one or more high priority devices.

13. The wireless network node of claim 11, wherein the processor is configured with processor-executable instructions to perform operations such that scanning the one or more frequencies to determine spectrum usage comprises determining one or more other signal characteristics of a signal of the identified one or more high priority devices.

14. The wireless network node of claim 11, wherein the processor is configured with processor-executable instructions to perform operations such that scanning one or more frequencies to determine spectrum usage comprises:
selecting a time interval and a frequency for scanning;
measuring a signal power of a signal received from each of the identified one or more high priority devices; and
determining the maximum RF interference threshold of each of the identified one or more high priority devices based on the measured signal power of signals received from each of the identified one or more high priority devices.

15. The wireless network node of claim 11, wherein the processor is configured with processor-executable instructions to perform operations further comprising:
sending information from each wireless network node to at least one other wireless network node.

16. The wireless network node of claim 11, wherein the processor is configured with processor-executable instructions to perform operations such that calculating a transmit power for one or more wireless network nodes based on the determined maximum RF interference threshold comprises:
determining a transmit power of each of the identified one or more high priority devices; and
calculating the transmit power for the one or more wireless network nodes based on the determined maximum RF interference threshold and the determined transmit power of each of the identified one or more high priority devices.

17. The wireless network node of claim 11, wherein the processor is configured with processor-executable instructions to perform operations such that calculating a transmit power for one or more wireless network nodes based on the determined maximum RF interference threshold of the identified one or more high priority devices comprises:
determining an incurred signal loss of a signal from the identified one or more high priority devices received at the one or more wireless network nodes;
determining a transmit power of each of the identified one or more high priority devices; and
calculating the transmit power for the one or more wireless network nodes based on the incurred signal loss and the determined transmit power of each of the identified one or more high priority devices.

18. The wireless network node of claim 17, wherein the processor is configured with processor-executable instructions to perform operations such that calculating the transmit power for each wireless network node based on the incurred signal loss and the determined transmit power of each of the identified one or more high priority devices comprises:
calculating the transmit power for the one or more wireless network nodes based on the incurred signal loss and the determined transmit power of the identified one or more high priority devices such that a signal transmitted at the calculated transmit power from the one or more wireless network nodes is estimated to arrive at the identified one or more high priority devices with a signal power that is less that the maximum RF interference threshold of the one or more high priority devices.

19-20. (canceled)

21. A wireless network node, comprising:
means for scanning one or more frequencies to determine spectrum usage;
means for identifying one or more high priority devices based on the scanning;
means for determining a maximum RF interference threshold of the identified one or more high priority devices based on the determined spectrum usage by the identified one or more high priority devices;
means for calculating a transmit power for one or more wireless network nodes based on the determined maximum RF interference threshold;
means for identifying as eligible to transmit a signal one or more wireless network nodes whose calculated transmit power is less than the determined maximum RF interference threshold and is greater than a receiver sensitivity of another of the wireless network nodes;
means for selecting from among the wireless network nodes that are eligible to transmit the signal one or more wireless network nodes to transmit based on the calculated transmit power of the one or more wireless network nodes; and
means for transmitting the signal from the selected one or more wireless network nodes at or below the calculated transmit power.

22. A non-transitory processor-readable storage medium having stored thereon processor-executable software instructions configured to cause a processor to perform operations for managing radio frequency (RF) spectrum usage by one or more wireless network nodes among a distributed plurality of wireless network nodes, comprising:
scanning one or more frequencies to determine spectrum usage;
identifying one or more high priority devices based on the scanning;
determining a maximum RF interference threshold of the identified one or more high priority devices based on the determined spectrum usage by the identified one or more high priority devices;
calculating a transmit power for one or more wireless network nodes based on the determined maximum RF interference threshold;
identifying as eligible to transmit a signal one or more wireless network nodes whose calculated transmit power is less than the determined maximum RF interference threshold and is greater than a receiver sensitivity of another of the wireless network nodes;
selecting from among the wireless network nodes that are eligible to transmit the signal one or more wireless network nodes to transmit based on the calculated transmit power of the one or more wireless network nodes; and
transmitting the signal from the selected one or more wireless network nodes at or below the calculated transmit power.

23. The non-transitory processor-readable storage medium of claim 22, wherein the stored processor-executable software instructions are configured to cause a processor to perform operations such that scanning the one or more frequencies to determine spectrum usage comprises measuring a received power of a signal from the identified one or more high priority devices.

24. The non-transitory processor-readable storage medium of claim 22, wherein the stored processor-executable software instructions are configured to cause a processor to perform operations such that scanning the one or more frequencies to determine spectrum usage comprises determining one or more other signal characteristics of a signal of the identified one or more high priority devices.

25. The non-transitory processor-readable storage medium of claim 22, wherein the stored processor-executable software instructions are configured to cause a processor to perform operations such that scanning one or more frequencies to determine spectrum usage comprises:
selecting a time interval and a frequency for scanning;
measuring a signal power of a signal received from each of the identified one or more high priority devices; and
determining the maximum RF interference threshold of each of the identified one or more high priority devices based on the measured signal power of signals received from each of the identified one or more high priority devices.

26. The non-transitory processor-readable storage medium of claim 22, wherein the stored processor-executable software instructions are configured to cause a processor to perform operations further comprising:
sending information from each wireless network node to at least one other wireless network node.

27. The non-transitory processor-readable storage medium of claim 22, wherein the stored processor-executable software instructions are configured to cause a processor to perform operations such that calculating a transmit power for one or more wireless network nodes based on the determined maximum RF interference threshold comprises:
determining a transmit power of each of the identified one or more high priority devices; and
calculating the transmit power for the one or more wireless network nodes based on the determined maximum RF interference threshold and the determined transmit power of each of the identified one or more high priority devices.

28. The non-transitory processor-readable storage medium of claim 22, wherein the stored processor-executable software instructions are configured to cause a processor to perform operations such that calculating a transmit power for one or more wireless network nodes based on the determined maximum RF interference threshold of the identified one or more high priority devices comprises:
determining an incurred signal loss of a signal from the identified one or more high priority devices received at the one or more wireless network nodes;
determining a transmit power of each of the identified one or more high priority devices; and
calculating the transmit power for the one or more wireless network nodes based on the incurred signal loss and the determined transmit power of each of the identified one or more high priority devices.

29. The non-transitory processor-readable storage medium of claim 28, wherein the stored processor-executable software instructions are configured to cause a processor to perform operations such that calculating the transmit power for one or more wireless network nodes based on the incurred signal loss and the determined transmit power of each of the identified one or more high priority devices comprises:
calculating the transmit power for the one or more wireless network nodes based on the incurred signal loss and the determined transmit power of the identified one or more high priority devices such that a signal transmitted at the calculated transmit power from the one or more wireless network nodes is estimated to arrive at the identified one or more high priority devices with a signal power that is less that the maximum RF interference threshold of the one or more high priority devices.

30. (canceled)
